(19) United States
(12) Patent Application Publication
(10) Pub. No.: US 2013/0022836 A1
(43) Pub. Date: Jan. 24, 2013

(54) BRAZED COATED DIAMOND-CONTAINING MATERIALS

(71) Applicants: Thomas C. Easley, Bexley, OH (US); Yuanbo Lin, Lewis Center, OH (US); Dwight Dyer, Kingston, OH (US)

(72) Inventors: Thomas C. Easley, Bexley, OH (US); Yuanbo Lin, Lewis Center, OH (US); Dwight Dyer, Kingston, OH (US)

(73) Assignee: DIAMOND INNOVATIONS, INC., Worthington, OH (US)

(21) Appl. No.: 13/552,907

(22) Filed: Jul. 19, 2012

Related U.S. Application Data
(60) Provisional application No. 61/509,711, filed on Jul. 20, 2011.

(51) Int. Cl. B32B 15/04; B23K 1/19; H05B 6/02; H05B 6/64; B23K 33/00; B23K 26/00; B23K 1/20; B23K 1/008

(52) U.S. Cl. 428/622; 228/208; 228/262.7; 228/122.1; 228/262.72; 219/678; 219/137 R; 219/121.85; 219/600; 428/634; 428/627

(57) ABSTRACT

The present disclosure relates to brazed coated diamond-containing materials and methods of producing brazed coated diamond-containing materials. The method for brazing the coated diamond-containing material may include bringing a braze metal into contact with the refractory metal layer and a substrate; heating at least the braze metal above the melting temperature of the braze metal; and bringing the braze metal into contact with the substrate to form a braze metal layer to join the diamond-containing material, braze metal layer, and substrate together. An advantage of the method may include that the brazing step may be performed in air, under ambient pressure, and without the need for a protective layer.

### CROSS-REFERENCE TO RELATED APPLICATIONS

This application is based on and claims the priority benefit of previously filed U.S. Provisional Patent Application No. 61/509,711, filed Jul. 20, 2011.

### TECHNICAL FIELD AND INDUSTRIAL APPLICABILITY

The present disclosure relates to brazed coated diamond-containing materials and methods of producing brazed coated diamond-containing materials. In particular, the method of brazing the coated diamond-containing material may be performed in air, under ambient pressure, and without the need for a protective layer and/or protective atmosphere.

Diamond-containing materials may be used for machining, cutting, grinding, polishing, and/or drilling metals, metal alloys, composites, glass, plastics, wood, rocks, geological formations, subterranean formations and ceramics. Diamond-containing materials may be bonded to substrates for the purpose of improving the performance of a tool by bonding a diamond-containing material to a substrate. In this way, the diamond-containing material may provide a hard, abrasive surface while the substrate may provide strength, toughness, and a means of attaching the tool to a tool holder. The substrate may provide strength and ease manipulation when the substrate is part of a tool, which integrates the diamond-containing material.

Many diamond-containing materials are formed as polycrystalline layers integrally bonded to a tungsten carbide substrate. In order to incorporate these materials into tools, they are cut to the desired size and shape and the substrate is brazed to a tool holder. The methods for this type of tool manufacturing are well known to those practiced in the art.

Other diamond-containing materials are formed as free standing bodies or layers. One of the problems of using these types of diamond-containing materials in a tool is that the diamond-containing material must be adequately bonded to the substrate to allow the tool to function effectively. For example, the bonding of a diamond-containing material to a substrate is typically carried out using a braze metal or alloy at a temperature of about 700 to about 1200° C. However, thermal oxidization of many diamond-containing materials takes place above temperatures of about 700° C. The thermally oxidized surface of the diamond-containing material interferes with the ability to braze the diamond-containing material to the substrate and/or deteriorates the integrity of the diamond-containing material.

For at least this reason, the methods used to braze a diamond-containing material to a substrate may involve the use of inert atmospheres, reduced pressures, or protective layers to prevent or minimize the oxidation of the diamond-containing material. While the uses of these techniques may produce satisfactory bonding results, these methods require the use of expensive process conditions which may not be practical on the industrial scale.

Therefore, it can be seen that there is a need for methods of producing brazed diamond-containing materials in air, under ambient pressure, and/or without the use of a protective layer; there is also a need for a brazed coated diamond-containing material which is capable of forming a strong bond between the diamond-containing material and the substrate. There is also a need for a brazed coated diamond-containing material which may be bound to a substrate in such a way that the oxidation of the diamond-containing material is minimized without the need for a protective layer. Further, there is a further need for brazing a coated diamond-containing material without the need for an inert atmosphere, a reduced pressure atmosphere, or a protective layer.

### SUMMARY

The following embodiments are not an extensive overview. The following description is not intended to identify critical elements of the various embodiments, nor is it intended to limit the scope of them.

In an embodiment, a brazed coated diamond-containing material comprises: a first diamond-containing material; an optional carbide layer comprising a refractory metal carbide, wherein the carbide layer may be in direct contact with the diamond-containing material, and the carbide layer may be continuous or discontinuous; a refractory metal layer comprising a refractory metal or a refractory metal alloy, wherein the refractory metal layer may be in direct contact with the carbide layer or the first diamond-containing material; a braze metal layer comprising a braze metal, wherein the braze metal layer may be in direct contact with at least a portion of the refractory metal layer; and a substrate, wherein at least a portion of a surface of the substrate may be in direct contact with the braze metal layer, and wherein the substrate comprises a second diamond-containing material, a cemented carbide, a polycrystalline cubic boron nitride (PcBN) superabrasive, a ceramic, a metal, a metal alloy, and/or combinations thereof.

In an embodiment, the first and second diamond-containing material may each independently comprise a single crystal diamond, a chemical vapor deposition diamond, a silicon carbide bonded diamond composite, a cobalt-polycrystalline diamond composite, a thermally-stable diamond composite, and/or combinations thereof. In an embodiment, the refractory metal may comprise tungsten, titanium, niobium, zirconium, tantalum, vanadium, chromium, or molybdenum. In an embodiment, the refractory metal alloy may comprise at least one refractory metal and, optionally, at least one non-refractory metal. In an embodiment, the refractory metal carbide may comprise at least one metal of the refractory metal or the refractory metal alloy. In an embodiment, the refractory metal layer may have a thickness of about 0.1 μm to about 100 μm. In an embodiment, the refractory metal or the refractory metal alloy may be deposited directly onto the diamond-containing material by a coating method to form the refractory metal layer and, optionally, the carbide layer. In a further embodiment, the coating method may comprise physical vapor deposition, chemical vapor deposition, sputtering, evaporation, electroless plating, electroplating, thermal diffusion, and/or combinations or series thereof. In an embodiment, the braze metal may comprise silver, copper, manganese, nickel, zinc, palladium, chromium, boron, titanium, tin, silicon, cadmium, gold, aluminum, indium or an alloy or composite thereof.

An embodiment includes a method for producing a brazed coated diamond-containing material comprising: brazing a coated diamond-containing material to a substrate, wherein the coated diamond-containing material comprises: a first diamond-containing material; an optional carbide layer comprising a refractory metal carbide, wherein the carbide layer may be in direct contact with the diamond-containing material, and the carbide layer may be continuous or discontinuous; a refractory metal layer comprising a refractory metal or a refractory metal alloy, wherein the refractory metal layer may be in direct contact with the carbide layer or the first diamond-containing material; wherein the brazing step can comprise: heating at least one of the braze metal, the refractory metal layer, and the substrate, to a temperature above a liquidus temperature sufficient to melt the braze metal; and bringing the melted braze metal into contact with both the refractory metal layer and the substrate layer to form a braze metal layer comprising silver, copper, manganese, nickel, zinc, palladium, chromium, boron, titanium, tin, silicon, cadmium, gold, aluminum, indium or an alloy or composite thereof, wherein the substrate comprises a second diamond-containing material, a cemented carbide, a polycrystalline cubic boron nitride (cBN) superabrasive, a ceramic, a metal, a metal alloy, and/or combinations thereof. In an embodiment of the method, the first and second diamond-containing material may each independently comprise a single crystal diamond, a chemical vapor deposition diamond, a silicon carbide bonded diamond composite, a cobalt-polycrystalline diamond composite, a thermally-stable diamond composite, and/or combinations thereof. In an embodiment of the method, the refractory metal may comprise tungsten, titanium, niobium, zirconium, tantalum, vanadium, chromium, molybdenum and/or combinations thereof. In an embodiment of the method, the refractory metal alloy may comprise at least one refractory metal and, optionally, at least one non-refractory metal. In an embodiment of the method, the refractory metal carbide may comprise at least one metal of the refractory metal or the refractory metal alloy. In an embodiment of the method, the refractory metal layer may have a thickness of about 0.1 μm to about 100 μm. In an embodiment of the method, the brazing step may comprise applying a heat source to heat at least the braze metal to the temperature of from about 700° C. to about 1000° C. In an embodiment of the method, the heat source may be at least one of a torch, a furnace, a microwave device, an arc welder, a laser, or an induction coil. In an embodiment of the method, the heat source may be an induction coil; and the temperature is maintained from about 700° C. to about 1000° C. for a time period of at least about 5 seconds. In an embodiment of the method, the brazing step may be performed under ambient air pressure and in air.

It is understood that both the foregoing general description and the following detailed description are exemplary and are intended to provide further explanation of the disclosed materials, products, and methods of production.

### BRIEF DESCRIPTION OF THE DRAWINGS

For the purpose of illustrating the embodiments enclosed herein, there are depicted in the drawings certain embodiments of a coated diamond-containing material and a brazed coated diamond-containing material. However, the methods and related products are not limited to the precise arraignments and instrumentalities of the embodiments depicted in the drawings.

FIG. 1 schematically depicts a coated diamond-containing material according to an exemplary embodiment; and

FIG. 2 schematically depicts a brazed coated diamond-containing material, wherein a coated diamond-containing material is brazed to a substrate according to an exemplary embodiment.

### DETAILED DESCRIPTION

As used herein, each of the following terms has the meaning associated with it in this section, unless otherwise explicitly stated.

The articles “a” and “an” are used herein to refer to one or more than one object of the article. By way of example, “an element” means one or more than one element.

The term “about” will be understood by persons of ordinary skill in the art to depend on the context in which it is used. As used herein, “about” encompasses variations from ±20%, including ±10%, ±5%, ±1%, and ±0.1%.

It is understood that any or all whole or partial integers between any ranges set forth herein are included.

The term “brazed” refers to an object which has been joined by a brazing process.

The term “brazing” means a metal-joining process whereby a braze metal or alloy is melted by heating the braze metal or alloy above the liquidus temperature of the braze metal or alloy and bringing the melted brazed metal into contact with at least two objects such that, when the temperature goes below solidus point of the braze metal or alloy, the two objects are joined (bound) by at least the braze metal or alloy to each other. For example, a braze metal or alloy may be melted and the liquid braze metal or alloy may be brought into contact with a coated diamond-containing material and a substrate material to fasten the diamond-containing material to the substrate.

The term “refractory metal” refers to an element having a melting point at or above about 1850° C. Examples of a refractory metal may include niobium, molybdenum, tantalum, tungsten, rhenium, titanium, vanadium, chromium, zirconium, hafnium, ruthenium, osmium, and iridium.

The term “refractory metal carbide” refers to carbide formed from at least one refractory metal.

The term “braze metal” or “braze metal alloy” refers to a metal or metal alloy having a melted point from about 500° C. to about 1849° C.

The term “cemented carbide” refers to a composite material formed from metal carbide crystals bonded together by a metallic matrix. For example, tungsten carbide crystals may be bonded together by a cobalt metal matrix.

The term “tungsten carbide” refers to the cemented carbide formed from tungsten carbide crystals bonded together by a cobalt metal matrix.

The term “polycrystalline diamond” refers to a material formed of diamond crystals which are sintered together to form a solid article. For example, one well known process involves the use of cobalt metal as a liquid phase sintering agent, and the resulting composite material contains a continuous matrix of sintered diamond crystals with interstitial cobalt.

The term “PCD” is an abbreviation for polycrystalline diamond.

The term “thermally stable diamond composite” refers to a PCD material which has had most or all of the cobalt removed from it, for example, by dissolving the cobalt in strong acids.

The term “continuous” refers to the form of a layer, wherein all of the material of the layer is interconnected; however, a continuous layer may contain holes or gaps in the layer as long as all of the material of the layer forms a single whole.

The term “discontinuous” refers to the form of a layer, wherein at least a portion of the material of the layer is not interconnected, such that one portion does not directly contact another portion. For example, a discontinuous layer may include multiple portions of the material of the layer, wherein the multiple portions are randomly distributed on a surface.

The term “alloy” refers to a mixture of more than one metal.

The term “non-refractory metal” means a metal having a melting point of less than 1850° C.

The term “liquidus temperature” means the temperature above which a metal or metal alloy is completely liquefied.

The term “solidus temperature” means the temperature below which a metal or metal alloy is completely solidified.

The term “ambient air pressure” refers to the atmospheric pressure to the environment of process in which the brazed diamond coated material is brazed and includes 760 mbar±20 mbar.

The term “in air” refers to the atmospheric gas mixture of the environment of process in which the brazed diamond coated material is brazed and includes 21% oxygen±5%.

Unless otherwise indicated, all measurements are in metric units.

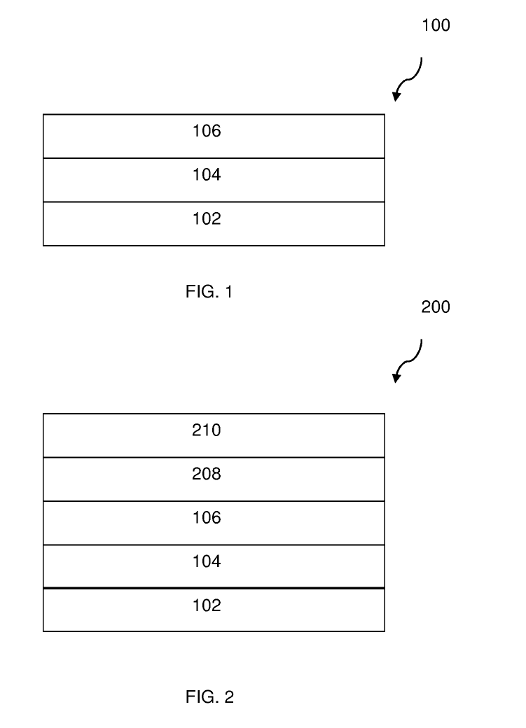

Referring to FIG. 1, in an exemplary embodiment, a coated diamond-containing material 100 may comprise: a diamond-containing material 102; an outermost coating layer 106, wherein the outermost coating layer may comprise a refractory metal or a refractory metal alloy; and an optional intermediate coating layer 104 comprising a refractory metal carbide, wherein the intermediate coating layer may be in direct contact with the diamond-containing material and the outermost coating layer, and wherein the intermediate layer may be continuous or discontinuous.

In an exemplary embodiment, the diamond-containing material may comprise a single crystal diamond, a chemical vapor deposition (CVD) diamond, a silicon carbide bonded diamond composite, a cobalt-polycrystalline diamond composite, a thermally-stable diamond composite, and/or combinations thereof. In an exemplary embodiment, the refractory metal may comprise tungsten, titanium, niobium, zirconium, tantalum, vanadium, chromium, or molybdenum. In another exemplary embodiment, the refractory metal alloy may comprise at least one refractory metal and, optionally, at least one non-refractory metal.

In an exemplary embodiment, the refractory metal carbide may comprise at least one metal of the refractory metal or the refractory metal alloy. In an embodiment, the outermost layer may have a thickness of about 0.1 μm to about 100 μm. In an exemplary embodiment, the refractory metal or refractory metal alloy may be deposited directly onto the diamond-containing material by a coating method to form the outermost coating layer and, optionally, the intermediate coating layer. In an exemplary embodiment, the coating method may comprise physical vapor deposition (PVD), chemical vapor deposition (CVD), sputtering, evaporation, electroless plating, electroplating, thermal diffusion or a combination or a series thereof.

In an exemplary embodiment of a process for producing a coated diamond-containing material, the process may comprise: depositing a refractory metal or a refractory metal alloy directly onto a diamond-containing material to produce a coated diamond-containing material comprising: a diamond-containing material; an outermost coating layer, wherein the outermost coating layer may comprise a refractory metal or a refractory metal alloy; and an optional intermediate coating layer which may comprise a refractory metal carbide; wherein the intermediate coating layer may be in direct contact with the diamond-containing material and the outermost coating layer, and wherein the intermediate layer may be continuous or discontinuous.

In an exemplary embodiment of the process, the diamond-containing material may comprise a single crystal diamond, a chemical vapor deposition diamond, a silicon carbide bonded diamond composite, a cobalt-polycrystalline diamond composite, a thermally-stable diamond composite, and/or combinations thereof. In an exemplary embodiment of the process, the refractory metal may comprise tungsten, titanium, niobium, zirconium, tantalum, vanadium, chromium, or molybdenum. In an exemplary embodiment of the process, the refractory metal alloy may comprise at least one refractory metal and, optionally, at least one non-refractory metal.

In an exemplary embodiment of the process, the refractory metal carbide may comprise at least one metal of the refractory metal or the refractory metal alloy. In an embodiment of the process, the outermost coating layer may have a thickness of about 0.1 μm to about 100 μm. In an embodiment of the process, the depositing step may comprise physical vapor deposition, chemical vapor deposition, sputtering, evaporation, electroless plating, electroplating, or combinations or a series thereof. In an embodiment of the process, the depositing step may be performed by chemical vapor deposition at a temperature of from about 550° C. to about 950° C.

Referring to FIG. 2, in an exemplary embodiment, a brazed coated diamond-containing material 200 may comprise: a first diamond-containing material 102; an optional carbide layer 104 which may comprise a refractory metal carbide, wherein the carbide layer may be in direct contact with the diamond-containing material, and the carbide layer may be continuous or discontinuous; a refractory metal layer 106 which may comprise a refractory metal or a refractory metal alloy, wherein the refractory metal layer may be in direct contact with the carbide layer or the first diamond-containing material; a braze metal layer 108 which may comprise a braze metal, wherein the braze metal layer may be in direct contact with at least a portion of the refractory metal layer; and a substrate 210, wherein at least a portion of a surface of the substrate may be in direct contact with the braze metal layer, and the substrate may comprise a second diamond-containing material, a cemented carbide, a polycrystalline cubic boron nitride (PcBN) superabrasive, a ceramic, a metal, a metal alloy, and/or combinations thereof.

In an exemplary embodiment, a brazed coated diamond-containing material may comprise a first diamond-containing material. The choice for a diamond-containing material is not particularly limited, so long as the diamond-containing material is capable of being coated by a refractory metal layer. The diamond-containing material may function as a superabrasive tool for such material removal applications as milling, turning, woodworking, dressing, drilling, mining, or the like. The diamond-containing material may function in wear resistant applications as nozzles, wear pads, wear surfaces, wear resistant cladding or liners, or the like. The method of attaching diamond may be useful for producing a wide variety of diamond-containing materials having other useful applications. The first diamond-containing material may comprise a single crystal diamond, a chemical vapor deposition (CVD) diamond, a silicon carbide bonded diamond composite, a cobalt-polycrystalline diamond composite, a thermally-stable diamond composite, and/or combinations thereof.

Different types of diamond may be suitable for different applications, depending on the properties required for each application. In general, diamond is used for its extreme hardness, chemical stability, and high thermal conductivity. Polycrystalline diamond, or PCD, is widely used as a tool for material removal applications such as milling, turning, woodworking, drilling and others. For many applications, PCD may be formed as a layer which is integrally bonded to a tungsten carbide substrate during the high-pressure, high-temperature PCD manufacturing process.

While PCD possesses the desirable properties of high hardness and strength; it may have less desirable properties compared to other diamond-containing materials. Due to the presence of cobalt in the material, PCD suffers from poor thermal stability and undergoes severe cracking when exposed to temperatures above about 700° C. PCD also suffers from poor corrosion resistance in some applications, in which the cobalt is subject to chemical attack. Other diamond-containing materials, including CVD diamond, silicon carbide bonded diamond composites, and thermally stable diamond composites, possess better thermal stability and corrosion resistance than PCD.

In applications where the diamond will be exposed to high temperatures, CVD diamond, silicon carbide bonded diamond composites, and thermally stable diamond composites may be preferred to PCD. Furthermore, CVD diamond, silicon carbide bonded diamond composites, and thermally stable diamond composites are not normally attached to a substrate material. To incorporate CVD diamond, silicon carbide bonded diamond composites, and thermally stable diamond composites in tools and other articles, it is desired to have a cost effective method of attachment to a substrate material.

Diamond-containing materials may be formed as thin layers, with thicknesses between about 0.1 mm to about 3.0 mm for example, including about 0.5 mm to about 2.0 mm. Due to their size, these layers are mechanically weak and require structural support to be used in a tool. The substrate's primary function may be to provide this structural support for the diamond. The choice of substrate material is dependent upon the requirements of each application. Tungsten carbide that is widely used as a substrate material may be often chosen for its high strength, toughness, hardness, and ability to be brazed to a steel tool holder.

Other substrates may be chosen depending on the requirements of the intended applications. Steel may be chosen for applications where the high hardness of tungsten carbide is unnecessary. Ceramic substrates may be chosen when chemical inertness is needed. Two pieces of diamond composite materials may be attached to each other in order to form a diamond composite with a thickness greater than either single layer.

In an embodiment, the brazed coated diamond-containing material may comprise a refractory metal layer. The refractory metal layer may comprise a refractory metal or refractory metal alloy. The choice of a refractory metal or a refractory metal alloy may not be particularly limited so long as the refractory metal layer or alloy may coat a diamond-containing material, withstand a temperature of at least about 700° C., may be wet or coated by a melted braze metal, and may form a strong bond with the diamond-containing material. In an exemplary embodiment, the refractory metal or metal alloy may comprise tungsten, titanium, niobium, zirconium, chromium, or molybdenum and/or combinations thereof. The refractory metal may be used to bond to a braze metal and to a diamond-containing material, and prevent oxidation of an underlying diamond-containing material. Further, in an exemplary embodiment, the refractory metal layer may have a thickness of about 0.1 micrometer to about 100 micrometers, for example, including about 0.1 micrometers to 25 micrometers, including about 0.5 micrometers to 2 micrometers, including about 1 micrometer to 2 micrometers, for example.

In order to form a strong bond with the diamond-containing material, the refractory metal may also be good carbide former. The formation of a carbide at the interface between the refractory metal and the diamond results in a high strength bond between the two materials. For example, tungsten may provide a combination of desirable properties, including high melting point, ability to form the tungsten carbide (WC), oxidation resistance, and compatibility with common brazing alloys.

The refractory metal or metal alloy may be deposited directly onto the diamond-containing material by a coating method to form the refractory metal layer. The method of coating the refractory metal onto the diamond-containing material is not particularly limited so long as the refractory metal forms a strong bond with the diamond-containing material and forms a predominantly continuous refractory metal layer on the diamond-containing material in such a way as to coat at least part of the diamond-containing material. The coating method for forming the refractory metal layer may comprise physical vapor deposition, chemical vapor deposition, sputtering, evaporation, electroless plating, electroplating, thermal diffusion or combinations or series thereof.

Chemical vapor deposition may be a particularly well suited coating method. Using CVD, high purity coatings may be applied with a very uniform and well controlled thickness. CVD coatings may be produced with a very strong bond between the coating and diamond-containing material.

In an exemplary embodiment, a brazed coated diamond-containing material may comprise an optional carbide layer. The carbide layer may comprise a refractory metal carbide or a refractory metal alloy carbide. When formed, the carbide layer may form a continuous or discontinuous layer of material which binds the refractory metal layer to the diamond-containing material. The metal carbide or metal alloy carbide may be formed at the interface of the refractory metal layer and diamond-containing material; therefore, the refractory metal layer may comprise at least the elements of the refractory metal, refractory metal alloy, and/or diamond-containing material.

The carbide layer may be formed during any step. If formed, the carbide layer may function to improve the adherence of the diamond-containing material and refractory metal layers to each other. The optional carbide layer may form a continuous layer containing holes or discontinuous layer containing gaps between the material of the carbide layer, wherein the first diamond-containing material and the refractory metal layer may come into direct contact with one another. Since the metal carbide layer may be more brittle than the diamond-containing material or the refractory metal, the thickness of the metal carbide layer should be minimized. Only a very thin layer may be advantageous in improving the adherence of the diamond-containing material to the refractory metal layer. In some embodiments, the carbide layer may have a thickness of about 0.005 μm to about 5 μm, for example. The refractory metal carbide may be formed from the reaction between the metal atoms contained in the deposited refractory metal and the carbon atoms contained in the diamond-containing material. As such the composition of the refractory metal carbide may be dependent upon the elemental composition of the refractory metal layer.

The carbide layer may be formed during an initial step, such as thermoreactive diffusion, which deposits only the carbide layer without a subsequent refractory metal layer. A refractory metal layer may be formed after the formation of the carbide layer, using a process such as physical vapor deposition, chemical vapor deposition, sputtering, evaporation, electroless plating, electroplating, thermal diffusion, and/or combinations or series thereof.

In an exemplary embodiment, the brazed coated diamond-containing material may comprise a braze metal layer. The braze metal layer may comprise a braze metal or braze metal alloy. The choice for the braze metal or braze metal alloy may not be particularly limited so long as the braze metal or alloy is appropriate for brazing the refractory metal layer and the substrate. The braze metal may comprise silver, copper, manganese, nickel, zinc, platinum, chromium, boron, titanium, tin, silicon, cadmium, gold, aluminum, indium or an alloy or composite thereof.

Braze alloys containing about 40% to about 60% Ag, for example, may be practical compositions for joining such materials to ferrous metals. Two examples of suitable braze metals for joining ferrous metals to tungsten coated diamond-containing materials are LUCAS-MILHAUPT® Braze 560 (LUCAS-MILHAUPT,® Inc., WI, USA), which has a composition of 56% Ag, 22% Cu, 17% Zn, and 5% Sn, and a liquidus of 650° C., and LUCAS-MILHAUPT® Braze 452, which has a composition of 45% Ag, 27% Cu, 25% Zn, and 3% Sn, and a liquidus of 680° C.

One suitable braze metal for brazing a tungsten coated diamond-containing material to tungsten carbide is LUCAS-MILHAUPT® Braze 495, which has a composition of 49% Ag, 16% Cu, 23% Zn, 7.5% Mn, and 4.5% Ni. Braze metals from other manufacturers with similar compositions may also be suitable. Braze 495 is formulated as a low-temperature braze, with a liquidus temperature of 700° C.

In an exemplary embodiment, brazed coated diamond-containing material may comprise a substrate. The substrate layer may comprise a second diamond-containing material, a cemented carbide, a polycrystalline cubic boron nitride (PcBN) superabrasive, a ceramic, a metal, a metal alloy, and/or combinations thereof.

The substrate may have two primary functions, for example. First, the substrate may provide structural support for the diamond layer, so that a relatively thin diamond layer may be utilized to provide abrasion resistance in a tool. Without the use of a supporting substrate, the diamond layer would not have sufficient strength to withstand the stresses applied during the tool application. Second, the substrate may provide a means of attaching the diamond layer to the tool holder. Without the relatively thick and strong substrate, attachment of the diamond to the tool holder may be much more difficult to accomplish.

In some embodiments, it may be desirable to make a diamond body with dimensions that exceed those possible to fabricate from a single diamond layer. In these cases, it is desired to have a means of constructing a body composed of two or more diamond layers bonded to one another. Multiple layers may be brazed together, in a single operation or in successive operations, to build a diamond body of the desired thickness.

In an exemplary embodiment, a method for producing a brazed coated diamond-containing material may comprise: brazing a coated diamond-containing material to a substrate. In an embodiment of the process, the coated diamond-containing material may comprise: a first diamond-containing material; an optional carbide layer which may comprise a refractory metal carbide, wherein the carbide layer may be in direct contact with the diamond-containing material, and the carbide layer may be continuous or discontinuous; a refractory metal layer comprising a refractory metal or a refractory metal alloy, wherein the refractory metal layer is in direct contact with the carbide layer or the first diamond-containing material.

In an exemplary embodiment of the process, the brazing step may comprise the following substeps in either order: heating at least one of the braze metal, the refractory metal layer, and the substrate, to a temperature above a liquidus temperature sufficient to melt the braze metal; and bringing the braze metal into contact with both the refractory metal layer and the substrate layer to form a braze metal layer. In an exemplary embodiment of the process, the braze metal may comprise silver, copper, manganese, nickel, zinc, palladium, chromium, boron, titanium, silicon, cadmium, gold, aluminum, indium or an alloy or composite thereof, for example. In an exemplary embodiment of the process, the substrate may comprise a second diamond-containing material, a cemented carbide, a polycrystalline cubic boron nitride (PcBN) superabrasive, a ceramic, a metal, a metal alloy, and/or combinations thereof, for example.

In an exemplary embodiment, the bringing substep may comprise bringing a braze metal into contact with the refractory metal layer and the substrate layer. The bringing substep may not be particularly limited so long as contact of the braze metal makes physical contact with both the refractory metal layer and the substrate. For example, the bringing substep may include the physical positioning of a braze metal between the refractory metal layer and the substrate using, for example, a braze metal in the form of a foil. Further, the bringing substep might also include a coating method such as physical vapor deposition, chemical vapor deposition, sputtering, evaporation, electroless plating, electroplating, or a combination or series thereof, whereby the braze metal is coated onto at least one of the refractory metal layer and the substrate before the heating substep.

In an exemplary embodiment, the heating substep is not particularly limited so long as at least one of the braze metal, the refractory metal layer, and the substrate are heated to a temperature above a liquidus temperature, or a melting point sufficient to melt the braze metal. In an embodiment, the brazing step may comprise applying a heat source to heat at least the braze metal to a temperature of from about 700° C. to about 1000° C., for example. Further, the heat source is not particularly limited so long as it is capable of heating at least the braze metal to a temperature of from about 700° C. to about 800° C., for example. As an example, the heat source may be at least one of a torch, a furnace, a microwave device, an arc welder, a laser, or an induction coil.

According to an embodiment, there are advantages to using an induction coil. Induction coils are relatively easy to use, inexpensive, and common. The use of induction coils for brazing non-diamond materials, for example, for brazing tungsten carbide cutting tools to steel tool bodies, is widespread. Brazing with an induction coil is simple, fast, effective, and requires very low capital startup cost. Optimal temperature ranges are dependent upon the braze metal selected. In general, the optimal temperature is just above the braze metal's liquidus temperature. During the brazing process, the brazing operator may watch the materials being brazed for evidence of melting. The brazing operator may turn off the power from the induction coil at the onset of braze flow.

In an exemplary embodiment, the method of brazing a diamond-containing material may include the ability to perform brazing at ambient atmospheric pressures and/or in the presence of air. This ability allows brazing to be conducted with brazing equipment, such as induction coils, that is widely available at low cost. Furthermore, the skill, expertise, and knowledge needed to induction braze in air is widespread. These factors should allow for the widespread adoption of diamond materials in tools and applications without requiring significant new investments by those currently engaged in production of brazed tools.

Uncoated diamond-containing materials may not be successfully brazed in ambient air pressure and in air. One theory which explains why air brazing of diamond fails holds that the oxygen present in the air reacts with the diamond and active metal elements contained in the braze metals. The oxygen and active metal elements react to form various oxide compounds which interfere with the bond between the braze metal and the diamond. Removal of oxygen is known to result in successful brazing of diamond using brazes that are not successful at air brazing. Oxygen may be removed by use of either an inert cover gas such as argon, or by removing all gaseous elements using a high vacuum chamber. By first coating the diamond-containing material with a refractory metal which forms a strong bond to the diamond, the need to use reactive metal elements in the braze is removed. Braze metals that are known to form strong bonds between the chosen refractory metal and the substrate, and which are compatible with air brazing, may then be utilized to join the coated diamond-containing material to the substrate. Further, the brazing still may be performed under ambient air pressure and adding air.

### EXAMPLE 1

Samples of diamond-containing materials were brazed to tungsten carbide substrates using the following method. The diamond-containing materials were a commercially available diamond composite known as VERSIMAX® (DIAMOND INNOVATIONS®, OH, USA). The diamond composite comprises approximately 80 vol. % diamond and 20 vol. % silicon carbide, with a small amount (<2.0 vol. %) of silicon. Samples of VERSIMAX® were produced by wire EDM (electrical discharge machining) cutting it into cylinders measuring 0.260″ diameter and 0.125″ thickness. Samples of tungsten carbide (8% Co content) were ground to a thickness of 0.125″ and were then wire EDM cut to 0.260″ diameter. The VERSIMAX® and tungsten carbide samples were cleaned by grit blasting the circular flat surfaces using glass beads and then by rinsing the parts in acetone. A CVD coating of W was applied to the VERSIMAX® samples. The thickness of the CVD coating was 8 microns. The VERSIMAX® samples were brazed to the tungsten carbide substrates by induction brazing in air using LUCAS-MILHAUPT® Braze 495 braze foil with Sta-Silv® Black Flux (Harris Products Group, OH, USA).

The brazed samples were then OD (outer diameter) ground to a diameter of 0.250″ and the shear strength of the braze joint was measured using an INSTRON® 4206 universal testing machine (INSTRON ® Corp., MA, USA). The samples were held in a shear testing fixture which applied a shear load to the braze joint. The samples were loaded to the point of failure, and the maximum shear stress was reported as the shear strength. A total of four (4) samples were tested, with shear strengths of 21.4, 38.9, 36.9, and 44.6 ksi. The samples were examined at 10× magnification in an optical microscope to evaluate the braze failure mode. In the three samples with shear strengths greater than 35 ksi, the failure was contained predominantly within the braze layer, indicating that the shear strength of the diamond-coating, coating-braze, and braze-WC interfaces exceeded the shear strength of the braze layer. This type of failure is desired for high strength braze attachments. In the sample that had shear strength of 21.4 ksi, areas of the W coating were exposed, indicating that some of the failure took place in the braze-coating interface, lowering the resulting shear strength of the braze joint. Poor wetting of the W coating by the braze is the likely explanation for the lower shear stress, and was most likely caused by incomplete cleaning of the coated diamond surface or the braze foil.

### EXAMPLE 2

Samples of diamond-containing materials were brazed to tungsten carbide substrates using the following method. The diamond-containing materials were a commercially available thermally stable PCD diamond composite known as COMPAX™ (DIAMOND INNOVATIONS®, OH, USA), which was a fully leached diamond composite substantially free of catalyst metal. Samples of thermally stable COMPAX™ were produced by first wire EDM (electrical discharge machining) cutting it into cylinders measuring 0.260″ diameter and 0.125″ thickness, and then removing the metal binder by a chemical leaching process. Samples of tungsten carbide (8% Co content) were ground to a thickness of 0.125″ and were then wire EDM cut to 0.260″ diameter. The COMPAX™ and tungsten carbide samples were cleaned by grit blasting the circular flat surfaces using glass beads and then by rinsing the parts in acetone. A CVD coating of W was applied to the COMPAX™ samples. The thickness of the CVD coating was about 5 microns. The COMPAX™ samples were brazed to the tungsten carbide substrates by induction brazing in air using LUCAS-MILHAUPT® Braze 495 braze foil with Sta-Silv® White Flux (Harris Products Group, OH, USA).

The brazed samples were then OD (outer diameter) ground to a diameter of 0.250″ and the shear strength of the braze joint was measured using an INSTRON® 4206 universal testing machine (INSTRON® Corp., MA, USA). The samples were held in a shear testing fixture which applied a shear load to the braze joint. The samples were loaded to the point of failure, and the maximum shear stress was reported as the shear strength. A total of four (5) samples were tested, with shear strengths of 51.9, 48.5, 49.8, 49.9, and 49.8 ksi. The samples were examined at 10× magnification in an optical microscope to evaluate the braze failure mode. In all five samples, the failure was contained predominantly within the braze layer, indicating that the shear strength of the diamond-coating, coating-braze, and braze-WC interfaces exceeded the shear strength of the braze layer. This type of failure is desired for high strength braze attachments. In three samples, there was evidence of cracking in the COMPAX™ material, indicating that the strengths of the braze and of the braze/COMPAX™ interface bond exceeded the failure stress of the COMPAX™ material.

### EXAMPLE 3

Samples of diamond-containing materials were brazed to tungsten carbide substrates using the following method. The diamond composite, known as VERSIMAX® (DIAMOND INNOVATIONS®, OH, USA), comprises approximately 80 vol. % diamond and 20 vol. % silicon carbide, with a small amount (<2.0 vol. %) of silicon. Samples of VERSIMAX® were produced by wire electrical discharge machining (EDM) by cutting it into cylinders measuring 0.260″ diameter and 0.125″ thickness. Samples of tungsten carbide (8% Co content) were ground to a thickness of 0.125″ and were then wire EDM cut to 0.260″ diameter. The VERSIMAX® samples were cleaned by grit blasting the circular flat surfaces using glass beads and then by rinsing the parts in acetone. The tungsten carbide samples were cleaned by grit blasting the circular flat surfaces using glass beads.

A coating of Cr was applied to the VERSIMAX® samples using a thermal diffusion method. The thickness of the coating was measured using SEM/EDAX to be about 1 micron. The coated VERSIMAX® samples were further cleaned by rinsing the parts in isopropyl alcohol The VERSIMAX® samples were brazed to the tungsten carbide substrates by induction brazing in air using LUCAS-MILHAUPT® Braze 495 braze foil with Sta-Silv® Black Flux (Harris Products Group, OH, USA).

The brazed samples were then OD (outer diameter) ground to a diameter of 0.250″ and the shear strength of the braze joint was measured using an INSTRON® 4206 universal testing machine (INSTRON® Corp., MA, USA). The samples were held in a shear testing fixture which applied a shear load to the braze joint. The samples were loaded to the point of failure, and the maximum shear stress was reported as the shear strength. A total of five (5) samples were tested, with shear strengths of 34.3, 43.1, 38.6, 43.9, and 42.3 ksi. The samples were examined at 10× magnification in an optical microscope to evaluate the braze failure mode. In all five samples, the failure was contained predominantly within the braze layer, indicating that the shear strength of the diamond-coating, coating-braze, and braze-WC interfaces exceeded the shear strength of the braze layer. This type of failure is desired for high strength braze attachments.

We claim:

1. A brazed coated diamond-containing material comprising:
a first diamond-containing material;
a refractory metal layer comprising a refractory metal or a refractory metal alloy, wherein the refractory metal layer is operably connected to the first diamond-containing material;
a braze metal layer comprising a braze metal, wherein the braze metal layer is in direct contact with at least a portion of the refractory metal layer; and
a substrate, wherein at least a portion of a surface of the substrate is in direct contact with the braze metal layer.

2. The brazed coated diamond-containing material of claim 1 further comprising a carbide layer, wherein the carbide layer is sandwiched between the first diamond-containing material and the refractory metal layer.

3. The brazed coated diamond-containing material of claim 2, wherein the carbide layer comprises a refractory metal carbide.

4. The brazed coated diamond-containing material of claim 1, wherein the substrate comprises at least one of a second diamond-containing material, a cemented carbide, a polycrystalline cubic boron nitride (PcBN) superabrasive, a ceramic, a metal, a metal alloy, and/or combinations thereof.

5. The brazed coated diamond-containing material of claim 1, wherein the first diamond-containing material comprises at least one of a single crystal diamond, a chemical vapor deposition diamond, a silicon carbide bonded diamond composite, a cobalt-polycrystalline diamond composite, a thermally-stable diamond composite, and/or combinations thereof.

6. The brazed coated diamond-containing material of claim 4, wherein the second diamond-containing material comprises at least one of a single crystal diamond, a chemical vapor deposition diamond, a silicon carbide bonded diamond composite, a cobalt-polycrystalline diamond composite, a thermally-stable diamond composite, and/or combinations thereof.

7. The brazed coated diamond-containing material of claim 1, wherein
the refractory metal comprises tungsten, titanium, niobium, zirconium, tantalum, vanadium, chromium, or molybdenum; and
the refractory metal alloy comprises at least one refractory metal.

8. The brazed coated diamond-containing material of claim 1, wherein the refractory metal alloy further comprises a non-refractory metal.

9. The brazed coated diamond-containing material of claim 3, wherein the refractory metal layer has a thickness of about 0.1 μm to about 100 μm.

10. The brazed coated diamond-containing material of claim 3, wherein the refractory metal or the refractory metal alloy is deposited onto the diamond-containing material by a coating method to form the refractory metal layer and, optionally, the carbide layer.

11. The brazed coated diamond-containing material of claim 10, wherein the coating method comprises physical vapor deposition, chemical vapor deposition, sputtering, evaporation, electroless plating, electroplating, thermal diffusion or combinations or series thereof.

12. The brazed coated diamond-containing material of claim 1, wherein the braze metal comprises at least one of silver, copper, manganese, nickel, zinc, palladium, chromium, boron, titanium, tin, silicon, cadmium, gold, aluminum, indium or an alloy or composite thereof.

13. A method comprising:
applying a refractory metal layer to a first diamond-containing material;
applying a heat source to heat a braze metal, the refractory metal layer, and a substrate at a predetermined temperature to melt the braze metal; and
bringing the melted braze metal into contact with the refractory metal layer and a substrate.

14. The method of claim 12 further comprising forming a braze metal layer between the substrate and the refractory metal layer.

15. The method of claim 13, wherein the braze metal comprises at least one of silver, copper, manganese, nickel, zinc, palladium, chromium, boron, titanium, tin, silicon, cadmium, gold, aluminum, indium or an alloy or composite thereof.

16. The method of claim 13, wherein the heat source is at least one of a torch, a furnace, a microwave device, an arc welder, a laser, or an induction coil.

17. The method of claim 13, wherein the heat source is an induction coil.

18. The method of claim 13, wherein the predetermined temperature is maintained from about 700° C. to about 1000° C. for a time period of at least about 5 seconds.

19. A brazing method of brazing a coated diamond-containing material to a substrate comprising:
applying a heat source to heat a braze metal, a refractory metal layer, and a substrate at a predetermined temperature to melt the braze metal; and
forming a braze metal layer between the refractory metal layer and the substrate.

20. The method of claim 19, wherein the diamond-containing material comprises:
a first diamond-containing material; and
a refractory metal layer comprising a refractory metal or a refractory metal alloy, wherein the refractory metal layer is operationally connected to the first diamond-containing material.

21. The method of claim 19, wherein the diamond-containing material further comprises a carbide layer, wherein the carbide layer is sandwiched between the first diamond-containing material and the refractory metal layer.

22. The method of claim 19, further comprising bringing the melted braze metal into contact with the refractory metal layer and the substrate;

23. The method of claim 19, wherein the braze metal layer comprises at least one of silver, copper, manganese, nickel, zinc, palladium, chromium, boron, titanium, tin, silicon, cadmium, gold, aluminum, indium or an alloy or composite thereof.

24. The method of claim 19, wherein the substrate comprises a second diamond-containing material, a cemented carbide, a polycrystalline cubic boron nitride (cBN) superabrasive, a ceramic, a metal, a metal alloy, and/or combinations thereof.

25. The method of claim 20, wherein the first diamond-containing material comprises at least one of a single crystal diamond, a chemical vapor deposition diamond, a silicon carbide bonded diamond composite, a cobalt-polycrystalline diamond composite, a thermally-stable diamond composite, and/or combinations thereof.

26. The method of claim 24, wherein the first diamond-containing material comprises at least one of a single crystal diamond, a chemical vapor deposition diamond, a silicon carbide bonded diamond composite, a cobalt-polycrystalline diamond composite, a thermally-stable diamond composite, and/or combinations thereof.

27. The method of claim 20, wherein
the refractory metal comprises tungsten, titanium, niobium, zirconium, tantalum, vanadium, chromium, or molybdenum; and
the refractory metal alloy comprises at least one refractory metal and, optionally, at least one non-refractory metal;

28. The method of claim 21, wherein
the carbide layer comprises at least one metal of the refractory metal or the refractory metal alloy.

29. The method of claim 21, wherein the carbide layer has a thickness of about 0.005 μm to about 5 μm.

30. The method of claim 6, wherein the predetermined temperature ranges from about 700° C. to about 1000° C. for a time period of at least about 5 seconds.

31. The method of claim 19, wherein the heat source is at least one of a torch, a furnace, a microwave device, an arc welder, a laser, or an induction coil.

32. The method of claim 19, wherein the heat source is an induction coil.

33. The method of claim 19, wherein the brazing method is performed under atmospheric pressure and in air.

34. The method of claim 19, wherein the brazing method is performed under inert gas.
